(19) United States
(12) Patent Application Publication
(10) Pub. No.: US 2009/0140035 A1
(43) Pub. Date: Jun. 4, 2009

(54) DATA BROKERAGE SYSTEM FOR MOBILE MARKETING

(76) Inventor: David H. Miller, Reston, VA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 12/123,421

(22) Filed: May 19, 2008

Related U.S. Application Data
(60) Provisional application No. 60/930,866, filed on May 18, 2007.

(51) Int. Cl. G06F 19/00; G06K 19/06; G06K 19/067

(52) U.S. Cl. 235/375; 235/494; 235/492

(57) ABSTRACT

In one embodiment, a method comprises receiving data associated with a data set acquired by a mobile device, sending a first reference associated with an offering of a third party to the mobile device, storing a second reference associated with the offering of the third party based on an identifier of the mobile device such that the second reference is accessible by a device other than the mobile device. In some embodiments, the method can include sending information associated with a user of the mobile device to the third party. In some embodiments, the data set includes data associated with an image and/or a barcode. In yet other embodiments, the data set can include data from a radio-frequency identification device such as, for example, an RFID tag.

### CROSS-REFERENCE TO RELATED APPLICATION

This application claims priority to U.S. Patent Application Ser. No. 60/930,866, filed on May 18, 2007 and entitled “Data Brokerage System for Mobile Marketing,” which is incorporated herein by reference in its entirety.

### BACKGROUND

The invention relates generally to wireless communication, Internet and software development including, for example, systems and methods for delivering data related to a user of a mobile device to a third party and systems and methods for distributing content to multiple devices over a communication network.

Data entry and information review can be difficult when using a mobile communications device such as a mobile phone or personal digital assistant (PDA) when compared to completing the same tasks on a computer such as a PC or a notebook or laptop computer. Similarly, viewing content or information on a mobile device can be difficult because of the limited screen size of mobile devices. Some mobile devices include zooming and panning features that mitigate screen limitations, but frequent panning and zooming can be cumbersome and time consuming.

Data entry on mobile devices can be difficult because many mobile devices lack a full keyboard and require repeated actuation of single key to cycle through each alphanumeric character assigned to a particular key until the desired character is input. Various solutions have been suggested to simplify data entry on mobile devices. The number of keys on a mobile device has been increased such that fewer characters are assigned to any given key, thus reducing the average number of actuations per key to input a desired character. “Soft” keyboards have been implemented, which toggle between character sets such that similar types of characters are assigned to the keys on a mobile device in a single character set. For example, capital letters can be input with a single actuation of a key when one character set is activated, symbols can be input with a single actuation of a key when another character set is activated, and numeric digits can be input with a single actuation of a key when yet another character set is activated. Services using dictionaries have been included on mobile devices. Such services often use predictive text technologies to auto-complete and/or suggest the next word to be input. Such solutions have helped to simplify entry of data on mobile devices, but are often incomplete or inadequate solutions. For example, increasing the number of keys generally results in a larger device or smaller keys which are difficult to actuate with one's fingers or other input device such as a stylus. Users of devices with soft keyboards must cycle through the character sets to find the character set including the character of interest. Predictive text services are limited to words included in the dictionary, are often slow, and/or predict text incorrectly, requiring deletion of the incorrect text and manual re-entry of the correct text.

Text entry on mobile devices can be particularly cumbersome when a user of a mobile device must complete extensive forms required or requested by third parties, for example, registration forms, using the mobile device. Such forms often contain fields for information such as telephone number, address, demographic data, etc. requiring entry of many different types of characters. Entry of an address, for example, often requires capital letters, lowercase letters, numbers, and symbols, making such entries particularly difficult. Some mobile devices include services that store such frequently used data—name, telephone number, address, etc.—on the mobile device itself and identify fields to auto-fill with the necessary information. Although such services can eliminate the need to enter the information stored on the mobile device, they increase the risk of such information being compromised in the event the mobile device is lost, misplaced, or stolen. The consequences of such risks are especially acute when financial data and/or personal data such as a social security number are stored on the mobile device.

Barcodes have also been used in connection with mobile devices to simplify data entry on mobile devices. Barcodes (or codes) have been known for some time. They are a graphical representation of data, and when used with a reader are a machine-enabled method of data entry.

Use of barcodes to encode information is also known. Traditionally, barcodes were limited to linear codes used to encode numbers. Modern barcodes can use symbologies capable of encoding a wide variety of characters and information and include, for example, stacked barcodes and two-dimensional (2D) barcodes. Stacked barcodes are usually formed by vertically stacking multiple linear barcodes. 2D barcodes, or 2D codes, encode information in a two-dimensional matrix. Barcodes are used in many applications including, for example, identification of items for sale in grocery and department stores, document management, tracking of rental cars, airline baggage, mail and wildlife, and ticketing for sporting or entertainment events. When used with a barcode scanner or reader, barcodes can simplify the process of identifying an item. Additionally, when combined with a computer system, barcodes can be used, for example, to quickly and efficiently track movement or sales of a particular item, change attributes such as price of the item within a database, and record and/or retrieve historical data related to the item encoded with the barcode.

The use of barcodes by users of mobile communications devices, however, has been limited. For example, barcode scanning has been used together with mobile communications devices to trigger some action on a mobile communications device such as, for example, launch a web page, initiate an SMS, and/or place a call, but such systems do not provide for the linking of data from a barcode to personal data of a user of the mobile device producing the scan or to other systems such as Internet architecture and social networks for later review or viewing on more convenient devices such as PCs or laptop computers. Thus, users of mobile communications devices are unable to use barcodes to complete forms or later review aggregated barcode data, or to allow another party to review the barcode data from another device.

Furthermore, current barcode scanning systems used with mobile communications devices do not provide a wired method of post scan interaction. Specifically, interaction with data encoded in a code scanned with a cameraphone such as, for example, a website address is limited to the mobile device. The website address can be stored in the history or bookmarks of a mobile device and accessed to return to the site at a later time, but there is no integrated wired and/or alternate device follow-up. This creates a problem for the consumer who wants to scan a code and then follow up at a later point in time from an alternative channel such as a PC via wired Internet.

Thus, there is a need for simplifying the process of entering data on a mobile device without compromising personal data of a user of the mobile device and systems and methods to provide a coordinated place or method for follow-up to data developed by a mobile device.

### SUMMARY

In one embodiment, a method comprises receiving data associated with a data set acquired by a mobile device, sending a first reference associated with an offering of a third party to the mobile device, storing a second reference associated with the offering of the third party based on an identifier of the mobile device such that the second reference is accessible by a device other than the mobile device. In some embodiments, the method can include sending information associated with a user of the mobile device to the third party. In some embodiments, the data set includes data associated with an image and/or a barcode. In yet other embodiments, the data set can include data from a radio-frequency identification device such as, for example, an RFID tag.

In another embodiment, a method comprises receiving data associated with a product from a mobile device, the data being based on a data set acquired by a mobile device and associated with an indication of interest in the product, identifying the user associated with the mobile device based on an identifier uniquely associated with the user of the mobile device, and providing information associated with the user of the mobile device to a third party. In some embodiments, the providing includes sending information associated with the user of the mobile device to the third party. In other embodiments, the providing includes providing access to the information associated with the user of the mobile device to the third part. In yet other embodiments, information associated with the user of the mobile device can be added to a database including information associated with additional mobile device users having an interest in the product. In some embodiments, the third party can be given access to the database.

### BRIEF DESCRIPTION OF THE DRAWINGS

FIG. 1 shows a system block diagram of a data brokerage and content delivery system, according to an embodiment of the invention.

FIG. 2 shows a system block diagram of a data brokerage and content delivery system, according to an embodiment of the invention.

FIG. 3 shows an illustration of content delivery, according to an embodiment of the invention.

FIG. 4 shows an advertisement including a barcode, according to an embodiment of the invention.

FIG. 5 shows examples of mobile web-pages associated with the advertisement illustrated in FIG. 4.

FIG. 6 shows an example of a PC-based web-page associated with the advertisement illustrated in FIG. 4.

FIG. 7 shows an incentive-based advertisement including a barcode, according to an embodiment of the invention.

FIGS. 8-11 are examples of a Graphical User Interfaces associated with the advertisement illustrated in FIG. 7.

### DETAILED DESCRIPTION

Embodiments described herein can provide simplified exchange of information from users of mobile devices to third parties. Other embodiments can facilitate review of content accessed by a mobile device using a PC, laptop, or other device.

For example, a user of a mobile device such as a cameraphone, for example, can use the cameraphone to scan a barcode included in an advertisement. The scanned barcode can be decoded by the cameraphone and sent over a communications network, such as a cellular network, to a computer server. The computer server can use data decoded from the scanned barcode to determine a uniform resource locator (URL) associated with the advertisement and send the URL to the cameraphone. The user of the cameraphone can then view a web page referenced by the URL and choose to authorize the computer server to send personal information of the user to an advertiser. This information can include, for example, the user's name, address, telephone number, and/or other identifying information. Alternatively, the user can purchase the product advertised by authorizing the computer server to share financial information such as a credit card number with the advertiser.

In some embodiments, the computer server can store a second URL or reference link to a web page associated with the advertisement or barcode such that the user can access the URL or web page at a later time. For example, a user of a cameraphone can scan a barcode included with an advertisement and view a web page as described above. However, rather than authorize the computer server to share personal or financial information with the advertiser from the cameraphone, the user can access the web page from a PC or laptop computer at a later time using the second URL or reference stored by the computer server. Additionally, the second URL or reference link can be made accessible to other users. The second URL or reference link can, for example, be made available to users of a social networking site or delivered via electronic mail or an instant messaging protocol to associates or friends of the user of the mobile device.

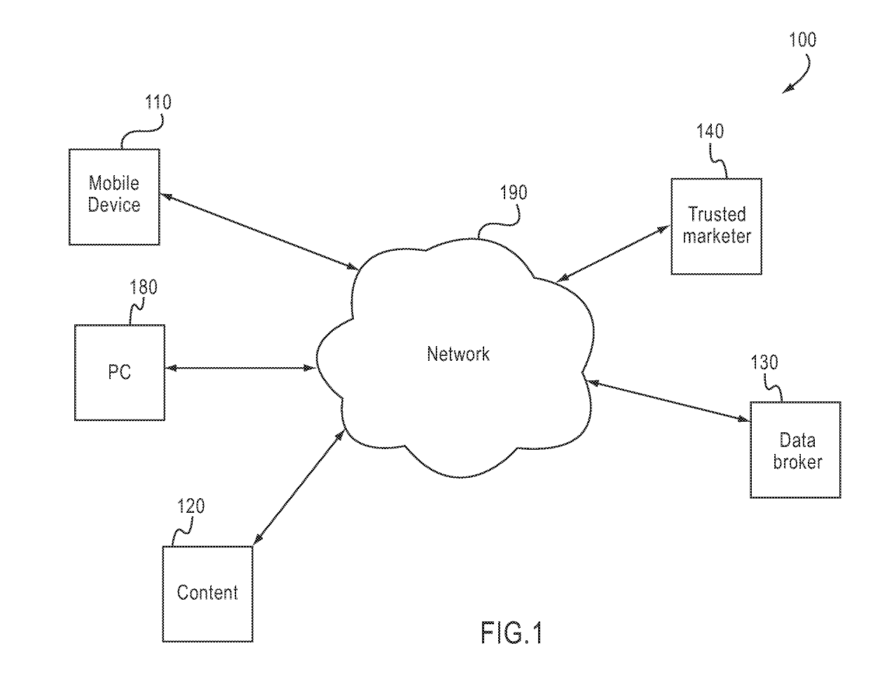

FIG. 1 shows a system block diagram of a data brokerage and content delivery system, according to an embodiment of the invention. System 100 includes a mobile device 110, content 120, data broker 130, trusted marketer 140, PC 180, and network 190. Mobile device 110, content 120, data broker 130, trusted marketer 140, and PC 180 are connected to network 190 such that mobile device 110, content 120, data broker 130, trusted marketer 140, and PC 180 are in communication one with another. Mobile device 110 can be any mobile device capable of communicating with network 190 and sending data associated with an offering of trusted marketer 140. For example, mobile device 110 can be a cameraphone or an RFID-enabled PDA. Trusted marketer 140 can be, for example, a marketer, advertiser or content provider providing content 120 in some relationship of trust with data broker 130. For example, trusted marketer 140 can be in a contractual relationship with data broker 130 to hold data provided by data broker 130 in confidentiality and use such data only in a manner approved by data broker 130 or a subscriber to data broker 130. Data broker 130 can be a service for storing personal and/or financial data, for example, of a subscriber to data broker 130 such as a user of mobile device 110 and sharing authorized data with trusted marketer 140. The amount and types of data stored by data broker 130 can be changed as additional data becomes relevant or other data becomes irrelevant. For example, although data such as shoe size may not be relevant in some data brokers, other data brokers can include such data if such data is determined to be useful or relevant.

In some embodiments, data broker 130 includes a subscription service that enables subscribers to manage personal information stored by data broker 130. For example, data broker 130 can include web-based account management for subscribers that can be used to enter and change personal information, associate a mobile device with the subscriber account or profile, and/or indicate which data may be shared by default with trusted marketer 140. In some embodiments, a subscriber can authorize other parties to access information associated with the subscriber account or profile. In other embodiments, data broker 130 includes web-based management for trusted marketers. Trusted marketers can establish accounts, agree to terms of service including confidentiality agreements, associate references, links, or URLs for content with data that can be provided by mobile devices, and view statistical and analytical information, for example, via web-based management.

In some embodiments, system 100 can include a data custodian (not shown in FIG. 1) for storing the personal, financial, and/or other data of subscribers to data broker 130. The data custodian can be, for example, a computer server and/or database that can be accessed by data broker 130 to retrieve data to be provided to trusted marketer 140.

In some embodiments, content 120, trusted marketer 140, and data broker 130 are implemented as independent computer servers each including a processor, computer memory, and an interface for connecting to and communicating with network 190. In other embodiments, content 120, trusted marketer 140, and data broker 130 are implemented as processes such as, for example, servlets or virtual machines on shared computer servers.

A user of mobile device 110 can use mobile device 110 to produce data associated with an offering of trusted marketer 140. U.S. Pat. No. 7,309,015, filed Jun. 28, 2005 and entitled “Mobile Device Gateway Providing Access to Instant Information,” which is incorporated herein by reference in its entirety, is an example of a system for scanning barcodes using a mobile device. In some embodiments, mobile device 110 can include a camera used to scan a barcode or an image included with an advertisement of an offering from trusted marketer 140. In other embodiments, mobile device 110 can be configured to receive radio-frequency identifier (RFID) data, for example, in a retail store, exhibition booth or a subway car associated with an advertisement or offering of trusted marketer 140. Mobile device 110 can send the data associated with the offering or advertisement to data broker 130 using network 190. In some embodiments, data produced by mobile device 110 is sent directly through network 190. In other embodiments, data produced by mobile device 110 is sent to an intermediary not shown in FIG. 1. An intermediary can be, for example, an interpreting service or image analysis service for interpreting data produced by mobile device 110. In some embodiments, for example, a barcode can be sent using network 190 to an intermediary to interpret data encoded in the barcode. The intermediary can send the interpreted data to mobile device 110 or can forward the interpreted data to data broker 130.

Data broker 130 can receive data produced by mobile device 110 over network 190. In some embodiments, data broker 130 can receive all data produced by mobile device 110 and associated with an offering of trusted marketer 140. In other embodiments, data broker 130 receives only some of the data produced by mobile device 110 and associated with an offering of trusted marketer 140. In some embodiments, data broker 130 can receive an identifier of mobile device 110 and/or an identifier of the user of mobile device 110. In some embodiments, the identifier can be, for example, a number or other identifier that uniquely identifies a user of mobile device 110 or that uniquely identifies mobile device 110. Data broker 130 can use the received data to determine a reference associated with the received data. The reference can be determined based on, for example, information embedded in an image produced by mobile device 110, data transmitted by an RFID device, and/or data encoded in a barcode used to look up a reference stored in a database. In some embodiments, the reference associated with the received data can be a link to or URL of a web page or other content available over network 190. For example, data broker 130 can determine a reference to content 120 offered by trusted marketer 140.

Data broker 130 can provide the reference to mobile device 110 based on the received identifier. For example, data broker 130 can use the identifier to determine a phone number or network address of mobile device 110 from a database including the subscriber profile of the user of mobile device 110. Mobile device 110 can use the reference to access content 120 over network 190. Content 120 can be, for example, a web page or registration form. In one embodiment, content 120 can be a registration web page for the user of mobile device 110 to register with a service offered by trusted marketer 140. The service can be, for example, a newspaper or magazine subscription. The registration web page can allow mobile device 110 to authorize data broker 130 to share personal data of a user of mobile device 110 with trusted marketer 140. In other embodiments, content 120 can be a page for completing a purchase by allowing a user of the mobile device 110 to authorize data broker 130 to share data necessary for completing the purchase with trusted marketer 140. For example, a user of mobile device 110 may authorize data broker 110 to share a credit card number, address, and/or telephone number with trusted marketer 140. In yet other embodiments, content 120 can be a page for registering for a contest that allows a user of mobile device 110 to authorize data broker 130 to share data with trusted marketer 140, and additionally allows the user of mobile device 110 to send data that is not stored by data broker 130 to trusted marketer 140. For example, content 120 can include a field for a preferred option or selection of an offering from trusted marketer 140, or some other field for data not stored by data broker 130, which the user of mobile device 110 can complete to provide the additional data to trusted marketer 140. Specifically, for example, content 120 can include fields allowing the user of mobile device 110 to input a size and a color for a shirt to be purchased from trusted marketer 140.

In some embodiments, data broker 130 determines a second reference associated with the data received from mobile device 110. The second reference can be a URL of or link to a web page or some other content associated with the reference sent to mobile device 110. In other embodiments, the second reference can be a URL of or link to a web page or content different from the reference sent to mobile device 110. For example, the reference sent to mobile device 110 can be a link to or URL of content designed for mobile devices such as, for example, a web page optimized for viewing on small screens or devices not capable of certain video formats and the second reference can be a link to or URL of a web page designed for viewing on a PC. Data broker 130 can store the second reference such that it is accessible by PC 180. PC 180 can be, for example, a standard desktop PC, a laptop or notebook computer, or any other device capable accessing the second reference over network 190.

In some embodiments, the second reference may be accessible over a network other than network 190. In some embodiments, data broker 130 can store the second reference such that it is accessible only to the user of the mobile device 110 that produced the data associated with the second reference. For example, the second reference can be stored in a user profile associated with the identifier received from mobile device 110 that is protected by a username and password. In other embodiments, the second reference can be stored such that it is generally accessible to other devices connected to network 190 or another network either using a web page or an application programming interface (API). For example, data broker 130 can store the second reference on a web page publicly accessible on the World-Wide Web.

In some embodiments, the second reference can be made accessible to the user of mobile device 110 and others via a social networking site. Data broker 130 can provide access to the second reference through a user profile or account on the social networking site of the user of mobile device 110, making the second reference available on the social networking site through the user's profile.

Alternatively, in some embodiments, data broker 130 can provide the second reference to other users of the social networking site such as, for example, other users of a social networking site selected or authorized by the user of mobile device 110. Similarly, in other embodiments, the second reference can be included in an electronic mail message or sent using an instant messaging protocol to others selected or authorized by the user of mobile device 110. Such embodiments allow the user of mobile device 110 to give others access to data produced by mobile device 110. Thus, the second reference can facilitate later viewing of content offered by trusted marketer 140 and result in aggregation of data produced by mobile device 110. Additionally, the second reference can allow trusted marketer 140 to deliver content optimized for the accessing device and to reach a greater audience as data produced by mobile device 110 and associated with offerings of trusted marketer 140 are made available to others by the user of mobile device 110.

In some embodiments, data produced by mobile device 110 and sent to data broker 130 can indicate an interest in a product. For example, a user of mobile device 110 can scan a barcode included on an advertisement provided by trusted marketer 140 to receive more information about a product. Data broker 130 can receive the data produced by mobile device 110 and provide trusted marketer 140 with data associated with mobile device 110 or the user of mobile device 110. In one embodiment, data broker 130 can provide mobile device 110 with a reference to a web page to authorize data broker 130 to share data with trusted marketer 140. In another embodiment, data broker 130 provides trusted marketer 140 with access to the data associated with mobile device 110 or the user of mobile device 110 without additional authorization from the user of mobile device 110. In some embodiments, data broker 130 can receive data produced by multiple mobile devices that indicate interest in a product and aggregate data associated with multiple mobile devices or users of mobile devices. For example, data broker 130 can maintain a list or database including demographic information of users of mobile devices that have produced data associated with a particular advertisement from trusted marketer 140. Data broker 130 can provide access to the list or database to trusted marketer 140 or other third parties. In some embodiments, data broker 130 supports an API for providing access to the list or database. In other embodiments, data broker 130 can send the list or database to trusted marketer 140 or another third party connected to network 190.

In other embodiments, data broker 130 can track or collect statistics or analytics related to the offerings of trusted marketer 140. For example, in some embodiments, data broker 130 can record or track the number of times data produced by mobile devices and sent to data broker 130 references or is associated with a particular offering of trusted marketer 140. In other embodiments, data broker 130 can record the number of times the second reference described above is used to access some content using, for example, click-through advertising techniques. In yet other embodiments, data broker 130 can track both references to a particular offering and uses of the second reference. In addition to recording the number of accesses, data broker 130 can record the times of access, demographic information of users accessing a reference, location data from a mobile device enabled with a global positioning system, and/or other information associated with accesses of references and/or content provided by trusted marketer 140. Data broker 130 can provide access to such statistics or analytics to trusted marketer 140 as described above in relation to data received from mobile devices and indicating an interest in an offering from trusted marketer 140. In some embodiments, data broker 130 can provide access to individual statistics separate from other statistics. In other embodiments, data broker 140 can provide access to multiple tracked statistics as a single data set.

In some embodiments, the user of mobile device 110 uses a web-based system to establish a subscriber account or profile with data broker 130. The user can, for example, choose a username and password and enter a credit card or bank account number to pay for access to the services of data broker 130 as part of establishing an account. After the user has established an account, the user can configure the account as part of an account setup procedure. For example, the user can enter personal data including, for example, name, address, telephone number, demographic data, preferred delivery information, credit card number, and/or other information. This data can be stored, for example, in a database accessible by data broker 130 and provided to trusted marketer 140 as authorized by the user. Additionally, the user can indicate which, if any, data can be shared with trusted marketer 140 by default. In another embodiment, data broker 130 can import personal data of a subscriber from an external database such as, for example, a database of cellular phone company as authorized by a user.

In some embodiments, the user can associate mobile device 110 with the account. In one embodiment, the web-based system can include a web page including a list of mobile devices compatible with data broker 130. The user can select mobile device 110 from the list of mobile devices, and input an identifier of mobile device 110. The identifier can be, for example, a telephone number, a network address, or a unique number associated with mobile device 110. In some embodiments, the web-based system can verify the identifier by, for example, requesting an acknowledgement from mobile device 110 before associating mobile device 110 with the subscriber account. The web-based system can, for example, send a short message service (SMS) message, instant message, electronic mail, or other message to mobile device 110 based on the identifier entered by the user. The message can include a link that the user of mobile device 110 can use to acknowledge that mobile device 110 should be associated with the subscriber account. In other embodiments, the user can simply input an identifier of mobile device 110 and the web-based system does not verify the identifier.

Following establishment and setup of an account, data broker 130 has access to data that can be used to identify mobile device 110 and data that can be forwarded to trusted marketer 140 as authorized by the user of mobile device 110. In addition to establishment and setup of an account, the web-based system can allow a user or subscriber to manage the account. For example, in some embodiments a user can change, add, and/or remove data and information from the subscriber account. In some embodiments, data produced by mobile device 110 and/or references and URLs determined by data broker 130 or associated with the data produced by mobile device 110 can be accessible through the subscriber account. This allows a user to manage the subscriber account and view a history of, for example, barcodes scanned by mobile device 110 and the URLs associated with the barcodes. The URLs can be a mobile URL, a PC URL, or both a mobile URL and a PC URL, for example. In other embodiments, the user of mobile device 110 can establish, setup, and/or change a subscriber account with data broker 130 at a point of sale or other place configured to assist the user with the account management.

In some embodiments, trusted marketer 140 uses a web-based system to establish an account with data broker 130 and to associate data that can be produced by mobile device 110 with two or more references or URLs. In one embodiment, trusted marketer 140 establishes an account as described above in relation to a user of mobile device 110. In some embodiments, trusted marketer 140 also agrees to use restrictions or conditions for data received from data broker 130 as part of the web-based account establishing. In some embodiments, trusted marketer 140 can have been provided with verification, a password or identification number, for example, indicating that trusted marketer 140 has previously agreed to the restrictions or conditions.

After establishing an account, trusted marketer 140 can use the web-based system to manage the account including associating references or URLs, for example, to content with data that can be produced by mobile device 110. For example, trusted marketer 140 can associate barcodes or barcode identifiers with URLs of mobile and PC content. In other embodiments, trusted marketer 140 can establish and/or modify an account with data broker 130 at a point of sale or other place configured to assist the user with the account management. In yet other embodiments, a representative of data broker 130 can assist trusted marketer 140 establish and/or modify an account with data broker 130.

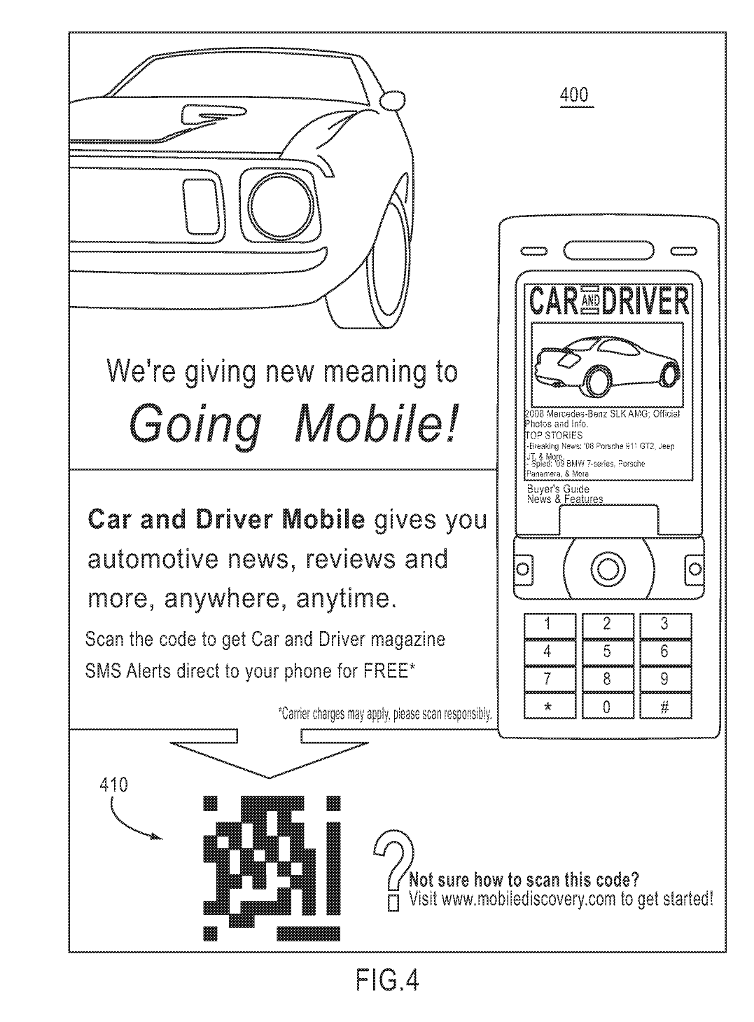

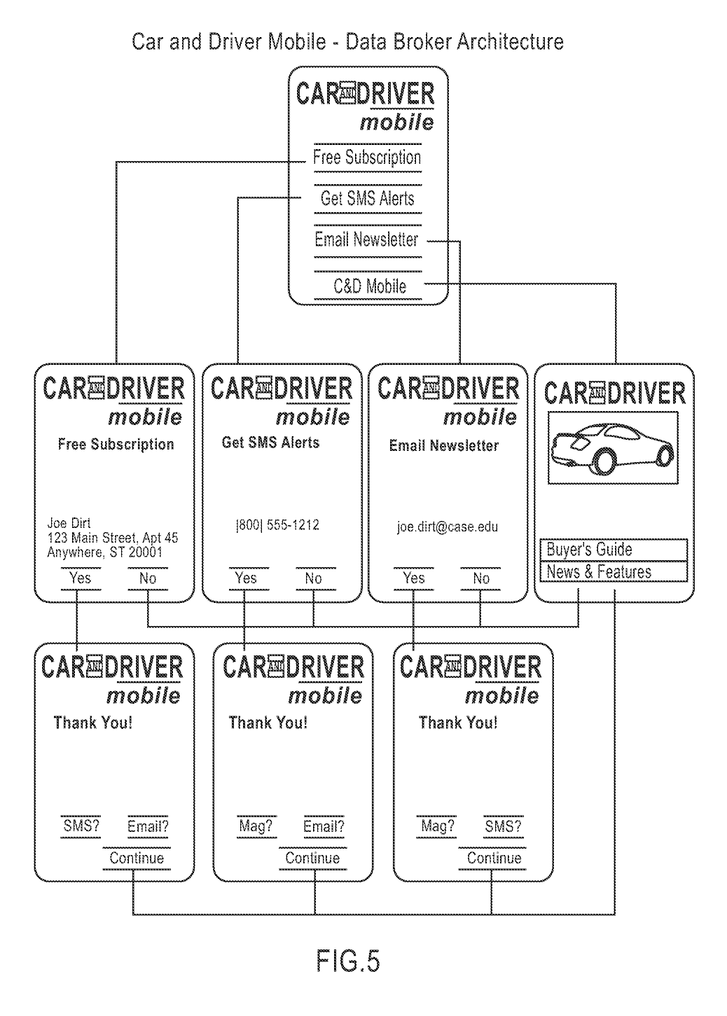

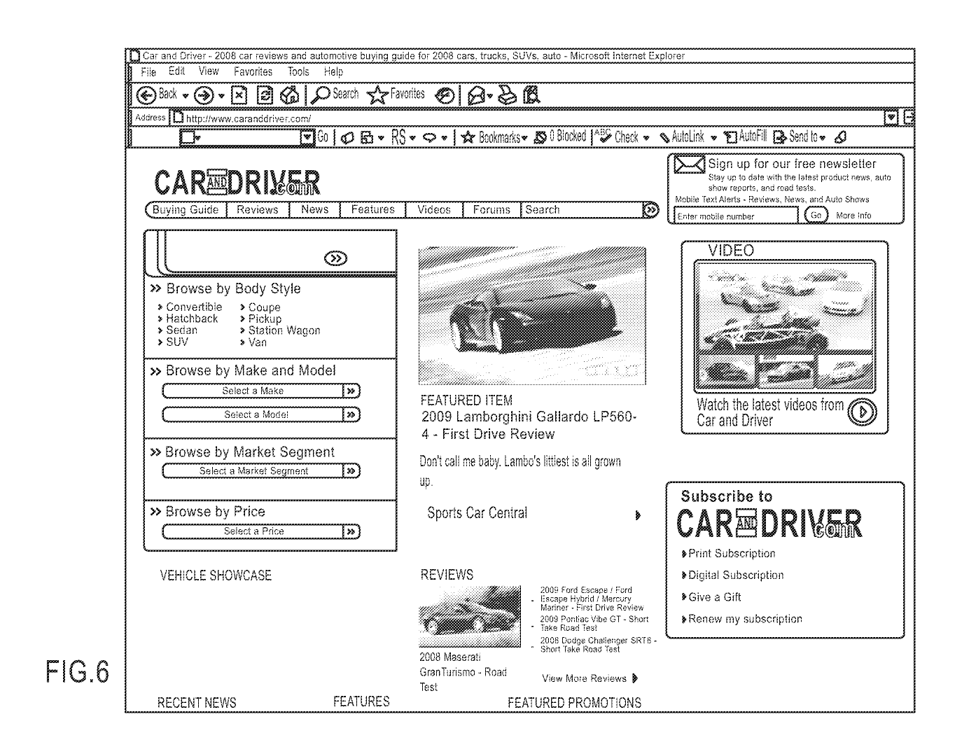

FIG. 4 shows an advertisement 400 including a barcode 410, according to an embodiment of the invention. When the barcode 410 is scanned, a user is presented with a mobile web-page associated with the advertisement of FIG. 4, according to an embodiment of the invention. FIG. 5 illustrates a series of possible mobile web-pages 510 presented to a user when the barcode 410 in FIG. 4 is scanned. In some embodiments, the user is alternatively presented with a PC web-page (see FIG. 6) associated with the advertisement 400 of FIG. 4, according to an embodiment of the invention. Trusted marketer 140 can, for example, associate the barcode of FIG. 4 with a URL of the mobile web-page and/or the PC web-page. Thus, the user of mobile device 110 can scan the advertisement including the barcode in FIG. 4 and mobile device 110 can send data associated with the barcode to data broker 130. Data broker 130 receives the data associated with the barcode of FIG. 4 from mobile device 110 and can, for example, provide the URL of the mobile web-page to mobile device 110 and store the URL of the PC web-page for later access by PC 180. The URL for the PC web-page of can be included as part of a user profile on a social networking site, according to an embodiment of the invention. In one embodiment, the URL of the PC web-page and/or the URL of a mobile web-page can be provided to a social networking site and can be stored as part of a user profile on a social networking site. Thus, the user of mobile device 110 or other person can use PC 180 to access the URL of the PC web-page from the social networking site.

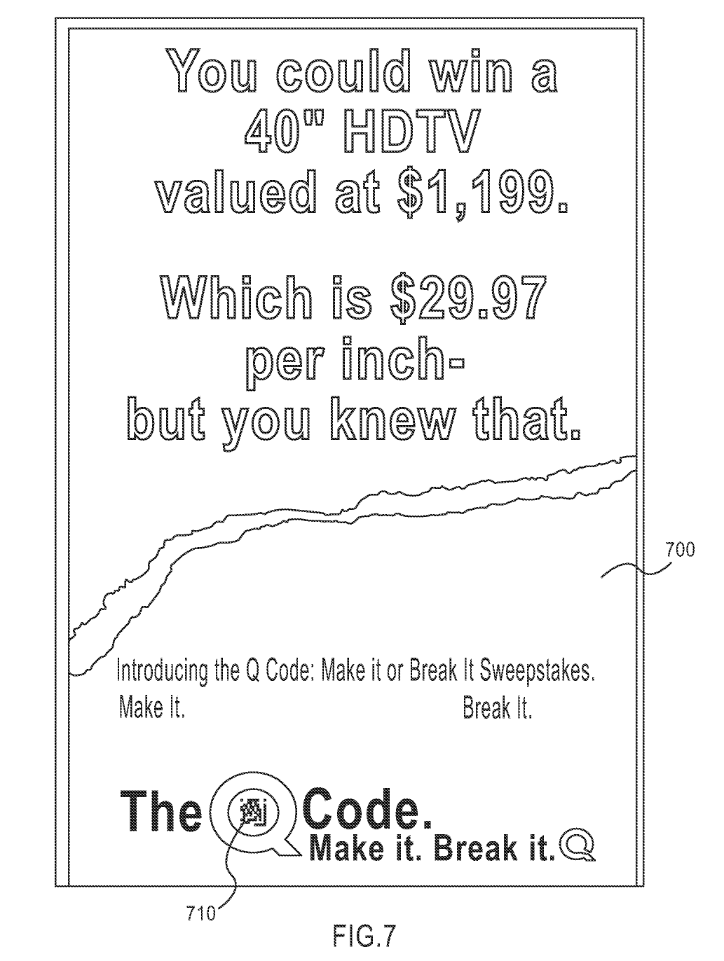

FIG. 7 illustrates an incentive-based advertisement 700 including a scannable 2D code 710. When a user scans the code 710 using their mobile device 110, the system stores the interaction (i.e., the information associated with the code) in the user's account. As a result, the user can consume the content at a later time (i.e., time shift their use of the material). The user can also channel shift their content viewing. In other words, instead of viewing information on their mobile device, the user can opt to retrieve the content using a PC-based link at a later time by accessing their account. In some embodiments, the user can store scans using, for example, any one of RSS, Social Network sites, widgets, etc.

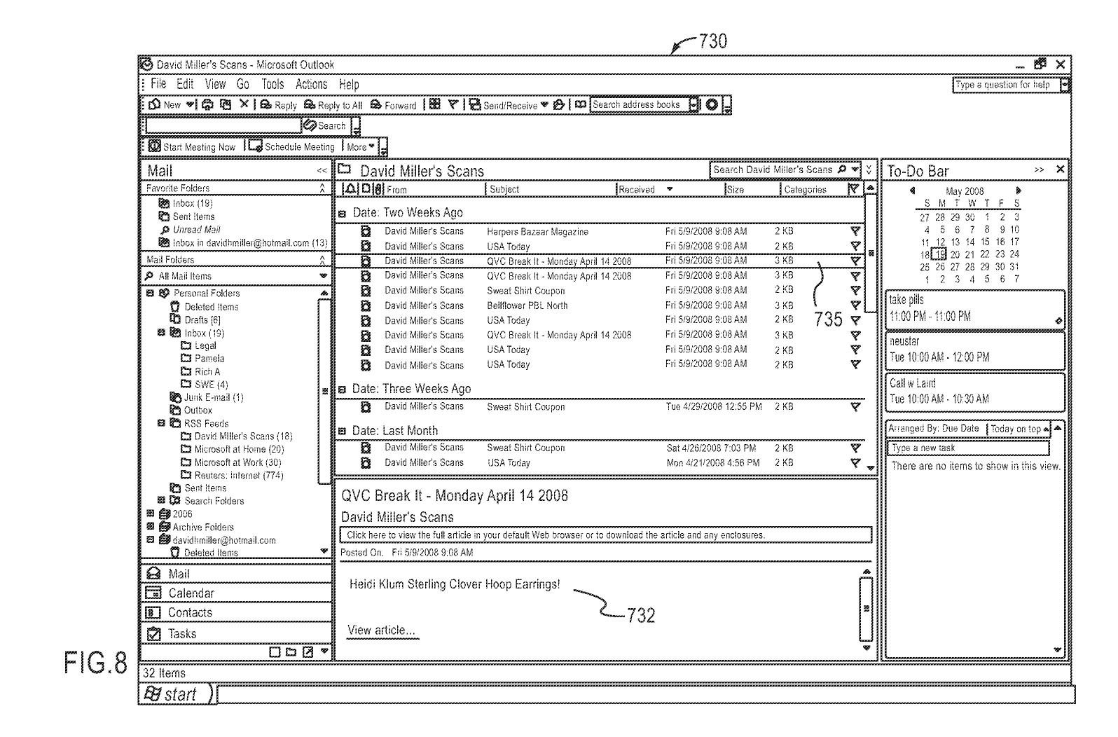

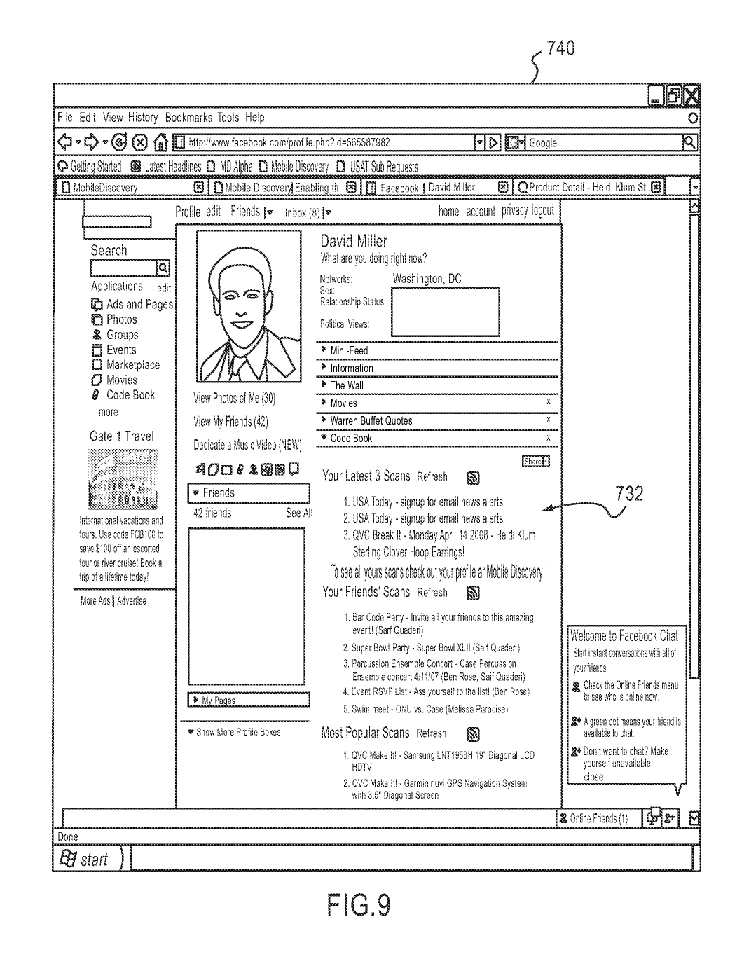

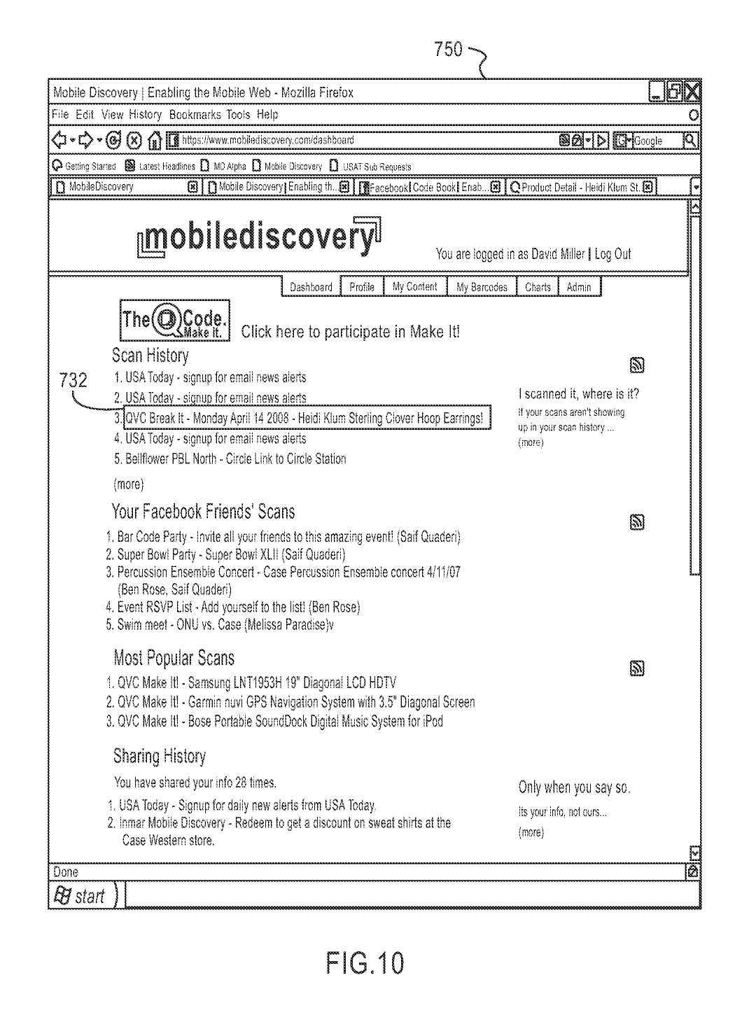

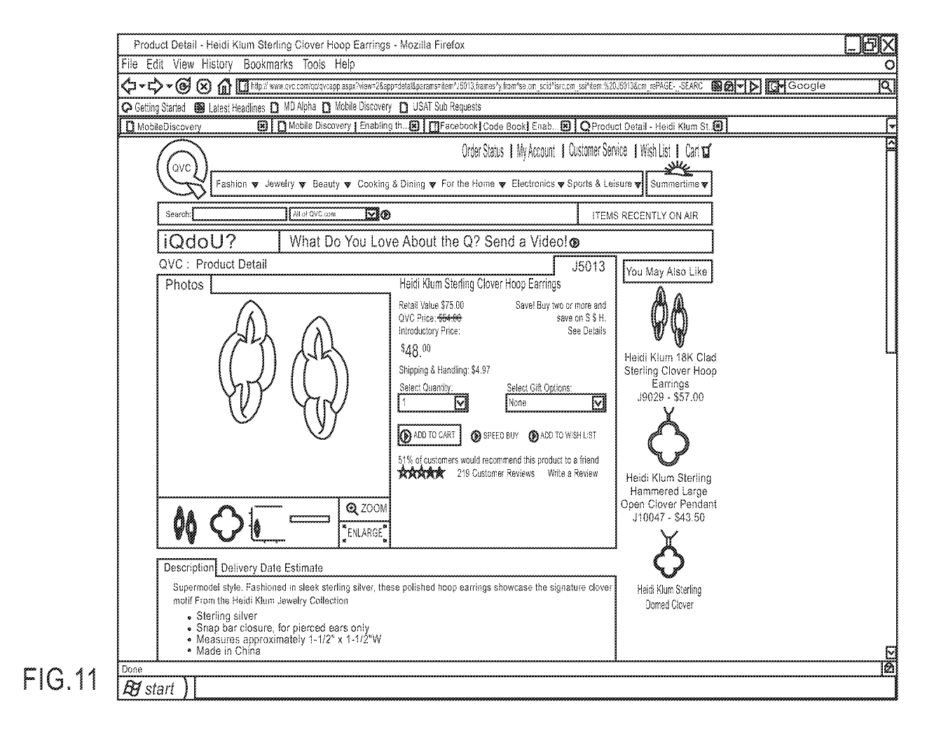

FIG. 8 is an example of a Graphical User Interface 730 that a user can interface with at some time after the code 710 has been scanned. After the user scans the code 710, the content associated with the code 710 is linked to PC-based content link 732 and is e-mailed to a user as an RSS feed 735. FIG. 9 is an example of a Graphical User Interface (GUI) 740 that a user can interface with at some time after the code 710 has been scanned. The GUI 740 is the user's social network account page to which the content link 732 is delivered after the code 710 is scanned by the user. FIG. 10 is an example of a Graphical User Interface 750 that a user can interface with at some time after the code 710 has been scanned. The GUI 750 is the user's account associated with a private branded service that can be used to control the delivery of the content link 732. When the user clicks on the content link 732 from any of the GUIs 730, 740, 750, the advertiser-defined content associated with that link (and the code 710) is delivered to the user.

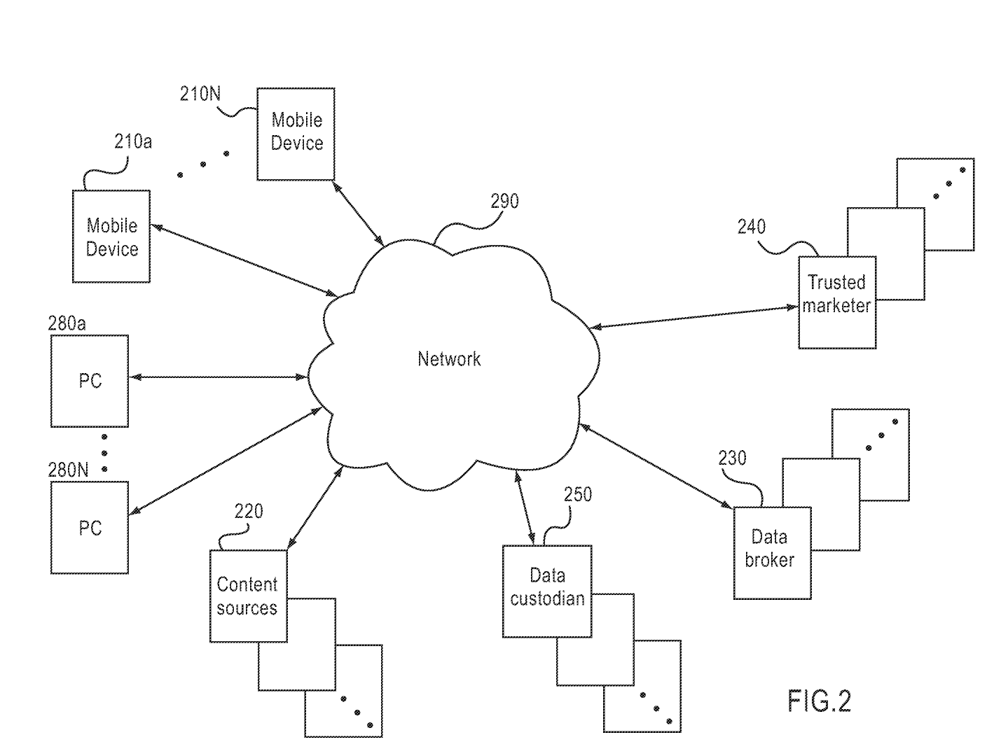

FIG. 2 shows a system block diagram of a data brokerage and content delivery system, according to an embodiment of the invention. FIG. 2 shows mobile devices 210a-210N, content sources 220, data brokers 230, trusted marketers 240, data custodians 250, PCs 280a-280N, and network 290. In some embodiments, as shown in FIG. 2, the methods and systems described above can be extended to include multiple mobile devices, PCs, content sources, data custodians, data brokers, and trusted marketers. For example, in some embodiments, data brokers 230 can be used to distribute processing across a number of processors and/or computer servers to balance the processing of data generated by mobile devices 210a-210N or data brokers 230 can be distributed geographically to increase reliability and speed of access. In other embodiments, many trusted marketers 240 can produce content that can be referenced by or included in data produced by mobile devices 210a-210N. In yet other embodiments, multiple data custodians 250 and/or content sources 220 can be used. Data custodians 250 and content sources 220 can include redundant storage of data for reliability and/or geographic distribution of data for reliability and faster access of information by data brokers 240, mobile devices 210a-210N, or PCs 280a-280N, for example.

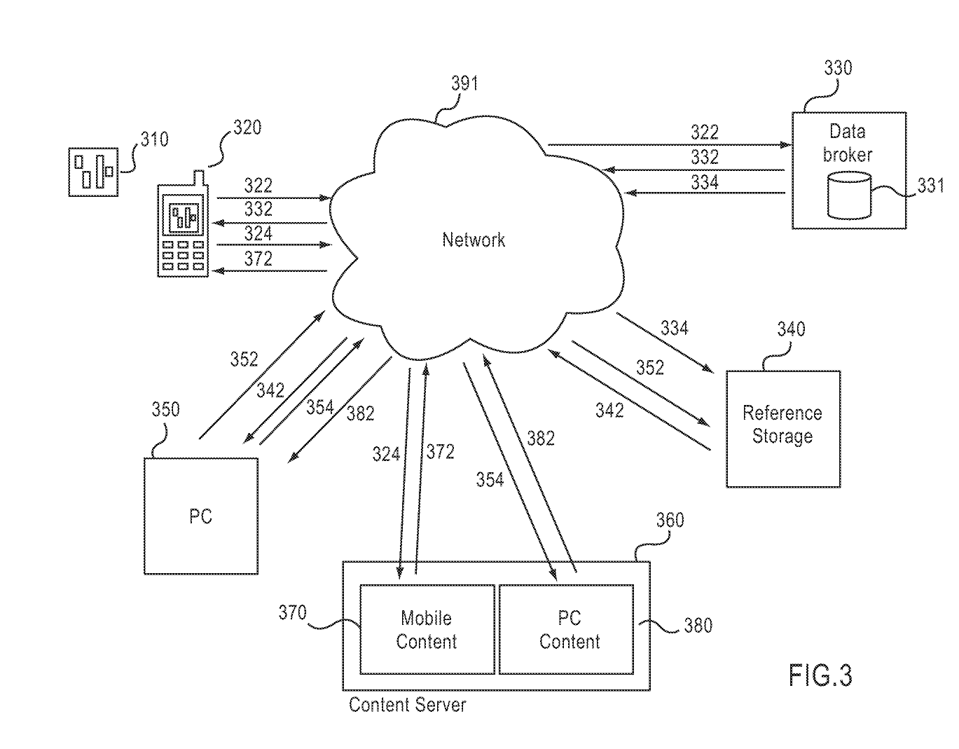

FIG. 3 shows an illustration of content delivery, according to an embodiment of the invention. Mobile device 320 scans barcode 310 and sends data 322 associated with barcode 310 to data broker 330. Data broker 330 uses data 322 to look up a mobile URL and a PC URL associated with barcode 310 in database 331. Data broker 330 sends data 332 to mobile device 320 including the mobile URL. Mobile device 320 receives data 332 and sends data 324 including at least a portion of the mobile URL to request mobile content 370 from content server 360. Content server 360 receives data 324 and sends data 372 including mobile content 370 to mobile device 320. Mobile device 320 receives data 372 and displays mobile content 370.

In addition to sending data 332 to mobile device 320, data broker 334 can store the PC URL in reference storage 340. As shown in FIG. 3, reference storage 340 is separate from data broker 330. In other embodiments, reference storage can be incorporated in data broker 330. In the embodiment shown in FIG. 3, data broker sends data 334 to reference storage 340 including the PC URL. Reference storage 340 receives and stores data 334 such that the PC URL is accessible to PC 350. Thus PC 350 can be used to access the PC URL associated with barcode 310. PC 350 sends data 352 to reference storage 340 requesting the PC URL. Reference storage 340 receives data 352 and sends data 342 including the PC URL. PC 350 receives data 342 and sends data 354 including at least a portion of the PC URL to request PC content 380 from content server 360. Content server 360 receives data 354 and sends data 382 including PC content 380 to PC 350. PC 350 receives data 382 and displays PC content 380. In other embodiments, as described above, other PCs, laptop computers, and/or other devices can also access the PC URL from reference storage 340.

Some embodiments described herein include a processor and a related processor-readable medium having instructions or computer code thereon for performing various processor-implemented operations. Such processors can be implemented as hardware modules such as embedded microprocessors, microprocessors as part of a computer system, Application-Specific Integrated Circuits (“ASICs”), and Programmable Logic Devices (“PLDs”). Such processors can also be implemented as one or more software modules in programming languages as Java, C++, C, assembly, a hardware description language, or any other suitable programming language. A processor according to some embodiments includes media and computer code (also can be referred to as code) specially designed and constructed for the specific purpose or purposes. Examples of processor-readable media include, but are not limited to: magnetic storage media such as hard disks, floppy disks, and magnetic tape; optical storage media such as Compact Disc/Digital Video Discs (“CD/DVDs”), Compact Disc-Read Only Memories (“CD-ROMs”), and holographic devices; magneto-optical storage media such as optical disks, and read-only memory (“ROM”) and random-access memory (“RAM”) devices. Examples of computer code include, but are not limited to, micro-code or micro-instructions, machine instructions, such as produced by a compiler, and files containing higher-level instructions that are executed by a computer using an interpreter. For example, an embodiment of the invention may be implemented using Java, C++, PHP, or other object-oriented programming language and development tools. Furthermore, computer code can include interpreted scripting languages such as for example, Python, Perl, and/or command-line scripts. Additional examples of computer code include, but are not limited to, control signals, encrypted code, and compressed code.

While certain embodiments have been shown and described above, it will be understood by those skilled in the art that various changes in form and details may be made. For example, some embodiments that have been described in relation to content delivery are also applicable to providing access to content for viewing on devices other than a mobile device. Furthermore, more than two URLs can be used to reference content. For example, more URLs can be used for various types of connection including, a URL for a mobile communications device such as a cameraphone, a URL for a PC or laptop, a URL for a mobile internet device, and/or a URL for a computing device with limited web browsing resources. Thus, the embodiments and descriptions above are not intended to be limiting to each separate description or embodiment, but it should be understood that the systems and methods described herein can include various combinations and/or sub-combinations of the components and/or features of the different embodiments described.

What is claimed is:

1. A method, comprising:
receiving data associated with a data set acquired by a mobile device;
sending to the mobile device a first reference associated with an offering of a third party;
storing a second reference based on an identifier of the mobile device, the second reference being associated with the offering, the second reference being accessible by a device other than the mobile device.

2. The method of claim 1, further comprising:
sending information associated with a user of the mobile device to the third party.

3. The method of claim 1, wherein the data set includes data associated with an image.

4. The method of claim 1, wherein the data set includes data associated with a barcode.

5. The method of claim 1, wherein the data set includes data from a radio-frequency identification device.

6. The method of claim 1, wherein the second reference is stored such that the second reference is accessible through a user profile.

7. The method of claim 1, further comprising:
providing access to the second reference to a fourth party.

8. The method of claim 1, further comprising:
recording data associated with a use of the second reference.

9. The method of claim 1, further comprising:
recording at least some of the received data associated with the data set.

10. The method of claim 1, further comprising:
providing to the third party data associated with a use of the second reference and at least some of the data associated with the data set.

11. A processor-readable medium storing code representing instructions to cause a processor to perform a process, the code comprising code to:
receive data associated with a data set acquired by a mobile device;
send to the mobile device a first reference associated with an offering of a third party;
store a second reference based on an identifier of the mobile device, the second reference being associated with the offering, the second reference being accessible by a device other than the mobile device.

12. The processor-readable medium of claim 11, further storing code representing instructions to cause a processor to perform a process, the code comprising code to:
send information associated with a user of the mobile device to the third party.

13. The processor-readable medium of claim 11, wherein the data set includes data associated with an image.

14. The processor-readable medium of claim 11, wherein the data set includes data associated with a barcode.

15. The processor-readable medium of claim 11, wherein the data set includes data from a radio-frequency identification device.

16. The processor-readable medium of claim 11, wherein the second reference is stored such that the second reference is accessible through a user profile.

17. The processor-readable medium of claim 11, further storing code representing instructions to cause a processor to perform a process, the code comprising code to:
provide access to the second reference to a fourth party.

18. The processor-readable medium of claim 11, further storing code representing instructions to cause a processor to perform a process, the code comprising code to:
record data associated with a use of the second reference.

19. The processor-readable medium of claim 11, further storing code representing instructions to cause a processor to perform a process, the code comprising code to:
record at least some of the received data associated with the data set.

20. The processor-readable medium of claim 11, further storing code representing instructions to cause a processor to perform a process, the code comprising code to:
provide to the third party data associated with a use of the second reference and at least some of the data associated with the data set.

21. A method, comprising:
receiving data associated with a product from a mobile device, the data being based on a data set acquired by the mobile device, the data being associated with an indication of interest in the product;
identifying a user associated with the mobile device based on an identifier uniquely associated with the user of the mobile device; and
providing information associated with the user of the mobile device to a third party.

22. The method of claim 21, wherein the providing includes sending information associated with the user of the mobile device to the third party.

23. The method of claim 21, wherein the providing includes providing to the third party access to the information associated with the user of the mobile device.

24. The method of claim 21, further comprising:
adding information associated with the user of the mobile device to a database, the database including information associated with additional mobile device users, the additional mobile device users having an interest in the product.
